(19) United States
(12) Patent Application Publication
(10) Pub. No.: US 2017/0219215 A1
(43) Pub. Date: Aug. 3, 2017

(54) MULTI-SENSORED SMART COOKING APPARATUS

(71) Applicant: HON HAI PRECISION INDUSTRY CO., LTD., New Taipei (TW)

(72) Inventor: LAP-SHUN HUI, PASADENA, CA (US)

(73) Assignee: HON HAI PRECISION INDUSTRY CO., LTD., New Taipei (TW)

(21) Appl. No.: 15/420,948

(22) Filed: Jan. 31, 2017

Related U.S. Application Data
(60) Provisional application No. 62/289,341, filed on Feb. 1, 2016.
(60) Provisional application No. 62/320,631, filed on Apr. 11, 2016.

(51) Int. Cl. F24C 7/08; H05B 3/68

(52) U.S. Cl. CPC F24C 7/081; H05B 3/68; A47J 36/00

(57) ABSTRACT

A multi-sensored smart cooking apparatus includes a setting module for setting at least one of a cooking time and a cooking temperature, a sensing module comprising at least one of a temperature sensor, a weight sensor, and a water level sensor, a controller coupled to the setting module and the sensing module, a cooking module coupled to the sensing module and the controller, where the controller is configured to adjust at least one of the cooking time and the cooking temperature in response to one or more sensed signals from the sensing module. The multi-sensored smart cooking apparatus is configured to turn off, when a sensed temperature of the cooking module is above a temperature threshold, when a sensed weight on the cooking module is below a weight threshold, or when a sensed water level is below a water level threshold.

### RELATED APPLICATION(S)

The present application claims the benefit of and priority to a provisional patent application entitled “COOKING APPARATUS AND METHOD,” Ser. No. 62/289,341, filed on Feb. 1, 2016, and a provisional patent application entitled “COOKING APPARATUS AND METHOD,” Ser. No. 62/320,631, filed on Apr. 11, 2016. The disclosures in these provisional applications are hereby incorporated fully by reference into the present application.

### TECHNICAL FIELD

The present application generally relates to food preparation appliances. More specifically, the present application relates to a multi-sensored smart cooking apparatus.

### BACKGROUND

Preparing a meal can be time consuming and require constant attention. For example, it may take hours to cook a flavor-rich soup or stew. It may also require a person to constantly attend the soup or stew to adjust the heat. For example, at first, the soup needs to be put on a high heat to make the liquid reach its boiling temperature. After bringing the liquid to a boil, the heat needs to be reduced, for example, to a medium heat to cook the content in the soup for another time period (e.g., an hour or so). Thereafter, the heat can be further reduced to a simmer for another time period (e.g., one or two hours). The person must constantly come back to check on the soup, for example, to adjust the heat or add water if needed. Thus, there is a need in the art for a multi-sensored smart cooking apparatus that can automatically control the cooking time and/or cooking temperature so as to reduce the amount of attention required by humans.

### SUMMARY

The present disclosure is directed to a multi-sensored smart cooking apparatus, substantially as shown in and/or described in connection with at least one of the figures, and as set forth in the claims.

### BRIEF DESCRIPTION OF THE DRAWINGS

FIG. 1A is a diagram of a multi-sensored smart cooking apparatus according to an exemplary embodiment of the present application.

FIG. 1B is a schematic block diagram of a multi-sensored smart cooking apparatus according to an exemplary embodiment of the present application.

FIG. 2 is a schematic block diagram of an application for a multi-sensored smart cooking apparatus according to an exemplary embodiment of the present application.

### DETAILED DESCRIPTION

The following description contains specific information pertaining to implementations in the present disclosure. The drawings in the present application and their accompanying detailed description are directed to merely exemplary embodiments. However, the present application is not limited to merely these exemplary embodiments.

Other variations and embodiments of the present application will occur to those skilled in the art. Unless noted otherwise, like or corresponding elements among the figures may be indicated by like or corresponding reference numerals. Moreover, the drawings and illustrations in the present application are generally not to scale, and are not intended to correspond to actual relative dimensions.

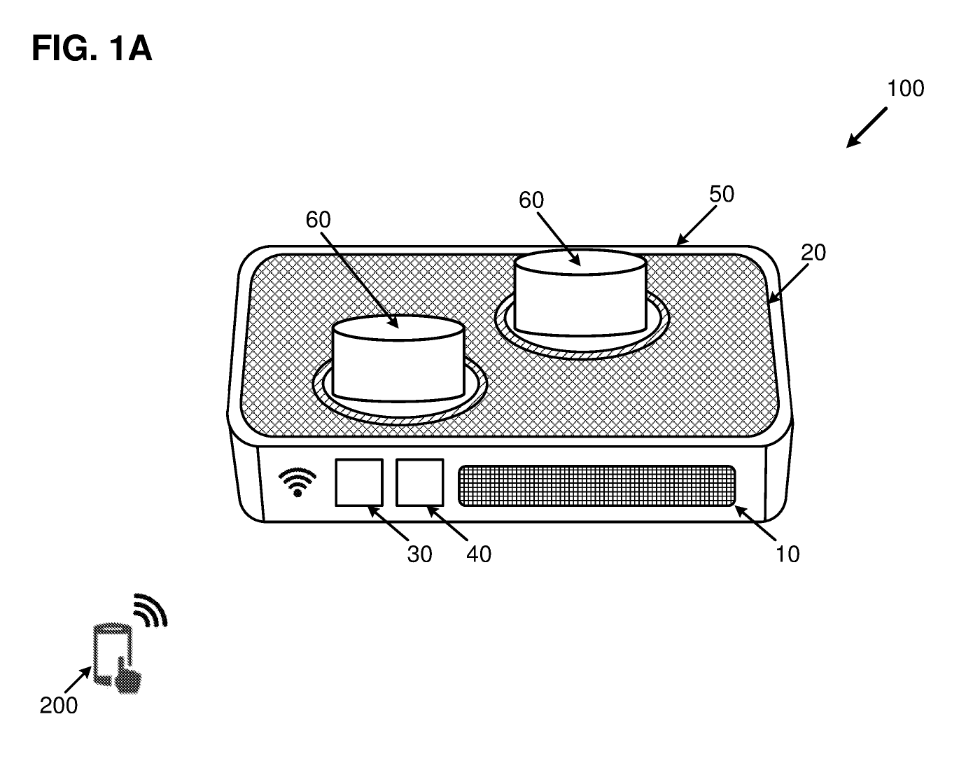

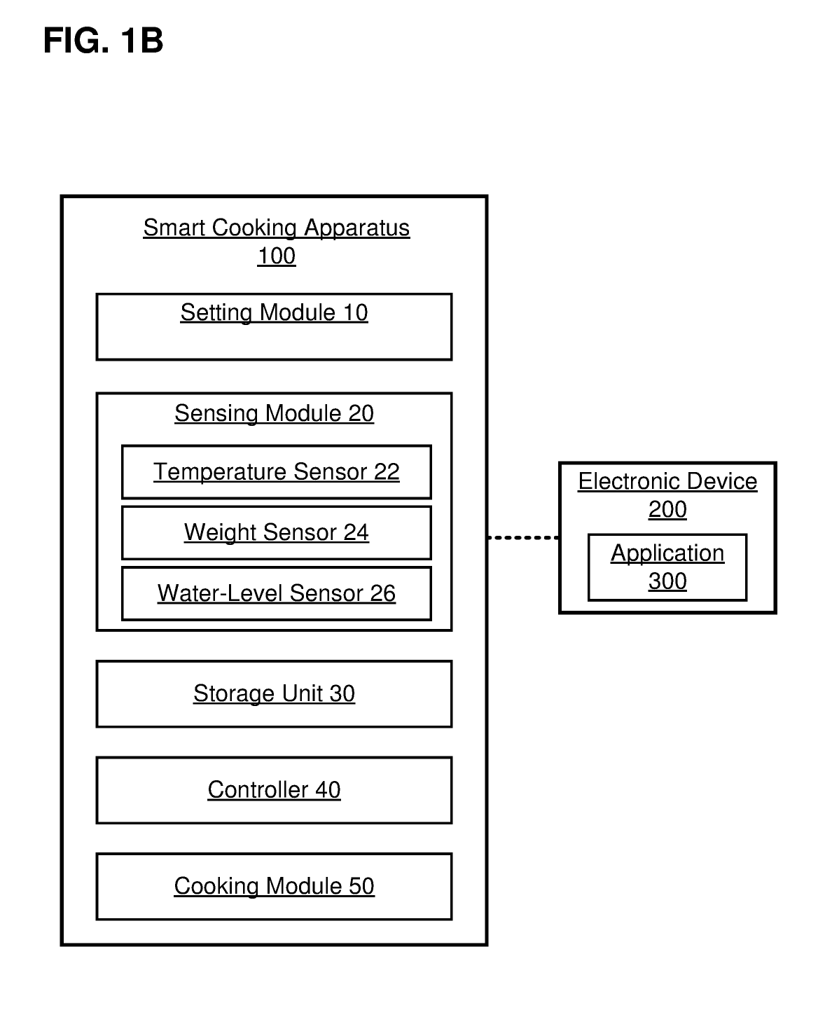

FIG. 1A is a diagram of a multi-sensored smart cooking apparatus according to an exemplary embodiment of the present application.

In the present exemplary embodiment, a multi-sensored smart cooking apparatus 100 includes a setting module 10, a sensing module 20, a storage unit 30, a controller 40, and a cooking module 50. The multi-sensored smart cooking apparatus 100 may be in communication with and/or controlled by an electronic device 200, for example, through a wireless link. It should be noted that the multi-sensored smart cooking apparatus 100 is merely an example of the smart cooking apparatus 100, other examples may comprise more or fewer components than those shown in the illustrated embodiment, or have a different configuration of the various components.

In FIG. 1A, the multi-sensored smart cooking apparatus 100 is a stove. For example, the cooking module 50 includes a cooking pot 60, where food items and/or water may be loaded from the top of the multi-sensored smart cooking apparatus 100. The sensing module 20 is disposed in or on the cooking module 50. The sensing module 20 may include a temperature sensor 22, a weight sensor 24, and a water level sensor 26 as shown in FIG. 1B. The details of the setting module 10, the sensing module 20, the storage unit 30, the controller 40, and the cooking module 50 are discussed below with reference to FIG. 1B.

FIG. 1B is a schematic block diagram of a multi-sensored smart cooking apparatus according to an exemplary embodiment of the present application. In the present exemplary embodiment, a multi-sensored smart cooking apparatus 100 includes a setting module 10, a sensing module 20, a storage unit 30, a controller 40, and a cooking module 50. In the present exemplary embodiment, the setting module 10, the sensing module 20, the storage unit 30, the controller 40, and the cooking module 50 in FIG. 1B may substantially correspond to the setting module 10, the sensing module 20, the storage unit 30, the controller 40, and the cooking module 50, respectively, as shown in FIG. 1A. It should be noted that FIG. 1B merely shows an example of the multi-sensored smart cooking apparatus 100, other examples may comprise more or fewer components than those shown in the illustrated embodiment, or have a different configuration of the various components.

The setting module 10 includes a control unit to set a plurality of parameters associated with preparing a variety of meals (e.g., soups and entries). In at least one exemplary embodiment, the plurality of parameters includes cooking time thresholds, cooking temperature thresholds, turn-on and turn-off times, and etc. For example, the cooking temperature threshold can be a preferred temperature for cooking a particular food item. The cooking time threshold can be in the intervals of ten minutes, forty-five minutes, sixty minutes, and up to, for example, twenty-four hours. The cooking temperature threshold can be adjusted, for example, from 0 to 500 degrees Fahrenheit (□).

The setting module 10 may include a graphic user interface that allows users to input the plurality of parameters. The setting module 10 may be coupled to the controller 40. The controller 40 can execute instructions from the setting module 10, and control the cooking module 50 to cook content thereon.

The sensing module 20 includes a temperature sensor 22, a weight sensor 24, and a water level sensor 26. The temperature sensor 22 is configured to sense a current temperature of the cooking module 50 and/or the cooking pot 60. The weight sensor 24 is configured to sense a presence of one or more food items in the cooking pot 60, and read a current weight of the one or more food items in the cooking pot 60. The water level sensor 26 is configured to detect a current water level in the cooking pot 60 on the cooking module 50. The temperature sensor 22, weight sensor 24, and water level sensor 26 are configured to send their sensed signals to the controller 40. The sensing module 20 can include other sensors, such as a camera, to sense the presence of one or more food items in the cooking pot 60, and to recognize and record the one or more food items in the storage unit 30.

In at least one exemplary embodiment, the storage unit 30 can be a storage device, such as a random access memory (RAM) for temporary storage of information, and/or a read only memory (ROM) for permanent storage of information. In at least one exemplary embodiment, the storage unit 30 can be an external storage device, such as an external hard disk, a storage card, or a data storage medium.

In at least one exemplary embodiment, the setting module 10 and sensing module 20 include computerized instructions in the form of one or more non-transitory computer-readable programs stored in the storage unit 30 (e.g., a computer-readable medium) and capable of being executed by the controller 40 (e.g., having at least one microprocessor) to control the cooking time and cooking temperature associated with the cooking module 50 based on the plurality of parameters set or entered through the setting module 10 and the sensed signals from the sensing module 20. That is, the functions of the setting module 10 and sensing module 20 are executed by the controller 40, for example, to control the cooking time and cooking temperature associated with the cooking module 50.

In at least one exemplary embodiment, the controller 40 may include at least one microprocessor. For example, the controller 40 is configured to receive the plurality of parameters from the setting module 10, and the sensed signals from the temperature sensor 22, weight sensor 24, and water level sensor 26 in the sensing module 20. The controller 40 is also configured to execute the computerized instructions in the form of one or more non-transitory computer-readable programs, that are stored in the storage unit 30, and associated with the setting module 10 and sensing module 20. The controller 40 is configured to control the cooking module 50 (e.g., the cooking time and cooking temperature) based on the plurality of parameters entered through the setting module 10 and the sensed signals from the sensing module 20.

In at least one exemplary embodiment, the cooking module 50 may include at least one cooking chambers coupled to at least one heating element. The cooking module 50 may be a gas cooking module or an electric cooking module. In an exemplary embodiment, the multi-sensored smart cooking apparatus 100 may be a gas cooker, where the cooking module 50 can include an intake valve controlled by the controller 40 to allow gas to flow into the cooking module 50 to heat the cooking module 50 and the food content inside the cooking pot 60. For example, the flow rate of gas through the intake valve can determine the amount of heat applied to the cooking module 50. That is, the greater the flow rate, the greater the amount of heat applied to the food content in the cooking pot 60 through the cooking module 50. In another exemplary embodiment, the multi-sensored smart cooking apparatus 100 may be an electric cooker, where the cooking module 50 includes an electric circuit (e.g., having resistors arranged in series and/or parallel) controlled by the controller 40 to vary the amount of heat applied to the cooking module 50, when an electrical current is applied to the electric circuit. It should be understood that electric cooking may also be inductive by controlling the strength of a magnetic field.

The temperature sensor 22, weight sensor 24, and water level sensor 26 may be disposed in and around the cooking module 50, and send their respectively sensed signals (e.g., sensed temperature, sensed weight, and sensed water level) to the controller 40, so that the controller 40 can adjust, among other things, the cooking time and cooking temperature associated with the cooking module 50 in response to one or more of the sensed signals.

In at least one exemplary embodiment, the user can use the setting module 10 to set a high heat for ten minutes, a medium heat for forty-five minutes, and a simmering heat for sixty minutes, for cooking a soup, for example. Thereafter, the controller 40 can apply a maximum flow rate of gas to heat the cooking module 50 for ten minutes, a medium flow rate of gas to heat the cooking module 50 for forty-five minutes, and a minimum flow rate of gas to heat the cooking module 50 for sixty minutes. As a result, the soup content in the cooking pot 60 are subjected to a high heat for ten minutes, a medium heat for forty-five minutes, and a simmering heat for sixty minutes.

The multi-sensored smart cooking apparatus 100 is configured to turn off, when a sensed temperature of the cooking module 50 and/or the cooking pot 60 is greater than a cooking temperature threshold. The multi-sensored smart cooking apparatus 100 is configured to turn off, when a sensed weight of the cooking pot 60 on the cooking module 50 is less than a weight threshold. The multi-sensored smart cooking apparatus 100 is configured to turn off, when a sensed water level in the cooking pot 60 on the cooking module 50 is less than a water level threshold. Each of the cooking temperature threshold, weight threshold and water level threshold may be determined based upon safety and/or normal cooking parameters.

The setting module 10 is configured to set a percentage limit on each of the weight of the food content and the water level in the cooking pot 60 to turn off the multi-sensored smart cooking apparatus 100 to prevent overcooking the food content and/or fire hazard, when at least one of the percentage limits is reached. For example, if the sensed weight of the cooking pot 60 on the cooking module 50 reaches a 20% limit, meaning that when the weight sensor 24 senses that only 20% of the original weight of the food content is remaining in the cooking pot 60, then the controller 40 is configured to turn off the multi-sensored smart cooking apparatus 100. For example, if the sensed water level in the cooking pot 60 reaches a 10% limit, meaning that when the water level sensor 26 senses that only 10% of the original water level is remaining in the cooking pot 60, then the controller 40 is configured to turn off the multi-sensored smart cooking apparatus 100.

In at least one exemplary embodiment, the controller 40 is configured to turn on and off, and adjust the cooking temperature of the multi-sensored smart cooking apparatus 100 based on inputs from the setting module 10 and sensed signals from the sensing module 20. For example, when the weight sensor 24 senses food content in the cooking pot 60, the sensing module 20 sends a signal to the controller 40 to allow the multi-sensored smart cooking apparatus 100 to be turned on. On the contrary, when the weight sensor 24 senses no food content in the cooking pot 60, the sensing module 20 sends a signal to the controller 40 to prevent the multi-sensored smart cooking apparatus 100 from being turned on.

If the temperature sensor 22 senses that the current temperature (e.g., the sensed temperature) of the cooking module 50 and/or the cooking pot 60 is greater than the cooking temperature threshold, the controller 40 can turn off the multi-sensored smart cooking apparatus 100, by, for example, completely shutting off the intake valve or opening a switch to prevent current from flowing into the electric circuit, to prevent overcooking the food content and/or fire hazard. In an alternative, if the temperature sensor 22 senses that the current temperature of the cooking module 50 and/or the cooking pot 60 is greater than the cooking temperature threshold, the controller 40 can adjust the multi-sensored smart cooking apparatus 100, by for example partially closing the intake valve or adjusting the resistance (e.g., increasing the resistance) in the electric circuit, to reduce the amount of heat generated by the heating element.

If the weight of the food content is reduced to the percentage limit from the original weight of the food content, or if the water level is reduced to the percentage limit of the first detected water level, or if the water level is reduced to the lowest permitted water level, the controller 40 can turn off the multi-sensored smart cooking apparatus 100, by, for example, completely shutting off the intake valve or opening a switch to prevent current from flowing into the electric circuit, to prevent overcooking the food content and/or fire hazard.

In at least one exemplary embodiment, the multi-sensored smart cooking apparatus 100 can be also connected to an electronic device 200, for example, through a wireless link 120. The electronic device 200 can be a cellular phone with an application 300 stored and installed thereon. The application 300 can be used to remotely control the multi-sensored smart cooking apparatus 100 over the wireless link 120 over the Internet or a Wi-Fi environment.

Among other advantages, the multi-sensored smart cooking apparatus 100 allows a user without prior cooking experience to prepare a soup or stew by setting the proper time, temperature and other cooking parameters at each cooking phase. For example, in the first phase, the multi-sensored smart cooking apparatus 100 may turn on high heat and bring the liquid quickly to boil. Boiling is achieved when the temperature peaks and stabilizes, irrespective of time. In the second phase, the heat is set to medium until the liquid drops by 5%. In the third phase, the heat is reduced to simmer until the liquid drops another 5%. In the last phase, the heat is applied only to keep the liquid warm, expecting the user will attend to the food. If not, the multi-sensored smart cooking apparatus 100 may shut down automatically when the liquid drops another 5%. Thus, the multi-sensored smart cooking apparatus 100 does not require any prior experience from the user to set the proper time, temperature and other cooking parameters at each cooking phase. However, it should be understood that, in another exemplary embodiment, if the user does not want a fully automated process, then the multi-sensored smart cooking apparatus 100 can alert the user from time to time during each phase such that the user can examine the readings and see if certain conditions need to be continued or some settings need to change. For example, the multi-sensored smart cooking apparatus 100 may send a notification through the application 300 to remind the user that it is time to add more water into the cooking pot 60, when the sensed water level in the cooking pot 60 is less than the water level threshold.

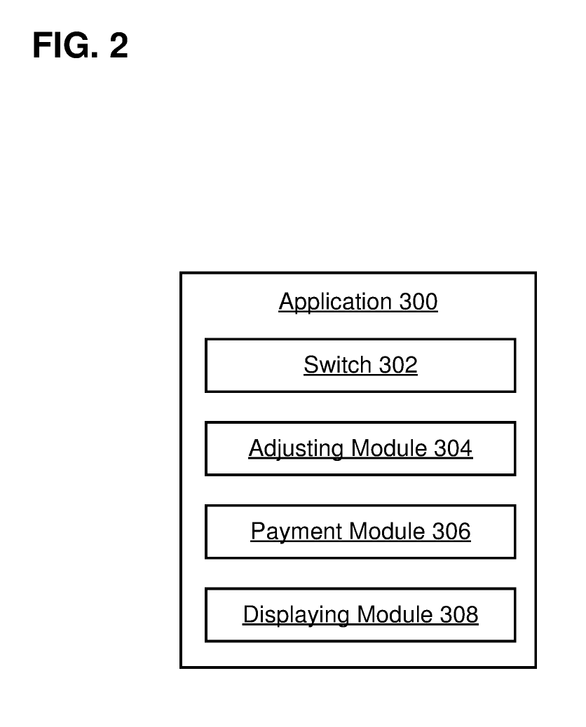

FIG. 2 is a schematic block diagram of an application for a multi-sensored smart cooking apparatus according to an exemplary embodiment of the present application. In FIG. 2, the application 300 can include a switch 302 and an adjusting module 304. The switch 302 is configured to remotely turn on and off the multi-sensored smart cooking apparatus 100 when the electronic device 200 is communicatively coupled to the multi-sensored smart cooking apparatus 100, for example, through the wireless link 120 in FIG. 1B. The adjusting module 304 is configured to communicatively couple to the controller 40, so that the flow rate of gas flowing into the cooking module 50 or the amount of current flowing into the electric circuit of the multi-sensored smart cooking apparatus 100 can be adjusted through the adjusting module 304. As such, the electronic device 200 is configured to remotely control and/or adjust the cooking temperature of the multi-sensored smart cooking apparatus 100.

In at least one exemplary embodiment, the application 300 also includes a payment module 306 and a displaying module 308. The payment module 306 can be coupled to a payment center, that is, the payment module 306 can be configured to calculate and provide the user with an access to pay fees for the gas or electricity consumed by the multi-sensored smart cooking apparatus 100. For example, the application 300 may be opened to pay utility (e.g., gas or electricity) bills through the payment module 306. The displaying module 308 can be configured to display a current utility consumption, for example, the gas usage (e.g., in cubic meters) or the power usage (e.g., in Watts) of the multi-sensored smart cooking apparatus 100.

In at least one exemplary embodiment, the application 300 may display the setting module 10 through a graphic user interface on the electronic device 200, so that the user can control the setting module 10 through the application 300. That is, the plurality of parameters of the multi-sensored smart cooking apparatus 100 can be set or entered remotely on the electronic device 200 through the application 300. In another exemplary embodiment, the controller 40 can also be accessed and controlled by the application 300.

In operation, the plurality of parameters can be set by the setting module 10. The switch 302 on the application 300 is simply clicked to start the cooking process (e.g., making soup). When the electronic device 200 is away from the multi-sensored smart cooking apparatus 100, such as in the user's office, the multi-sensored smart cooking apparatus 100 can be remotely controlled (e.g., turned on and off) by the switch 302 on the application 300. In addition, the flow rate of gas flowing through the gas intake valve, or the amount of current flowing into the electric circuit, of the multi-sensored smart cooking apparatus 100 can be adjusted through the adjusting module 304 on the application 300. Thus, among other advantages, by having the application 300 on the electronic device 200 and the sensing module 20 for monitoring the food content in the cooking pot 60, the user may be able to start a long cooking process remotely without worrying about overcooking the food or causing fire hazard.

The exemplary embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

We claim:

1. A multi-sensored smart cooking apparatus comprising:
a setting module for setting at least one of a cooking time and a cooking temperature;
a sensing module comprising at least one of a temperature sensor, a weight sensor, and a water level sensor;
a controller coupled to the setting module and the sensing module;
a cooking module coupled to the sensing module and the controller;
wherein the controller is configured to adjust at least one of the cooking time and the cooking temperature in response to one or more sensed signals from the sensing module;
wherein the multi-sensored smart cooking apparatus is coupled to an electronic device through a wireless link, and the electronic device is configured to remotely adjust at least one of the cooking time and the cooking temperature of the multi-sensored smart cooking apparatus.

2. The multi-sensored smart cooking apparatus of claim 1 wherein the multi-sensored smart cooking apparatus is a stove.

3. The multi-sensored smart cooking apparatus of claim 1 wherein the sensing module comprises the temperature sensor, the weight sensor, and the water level sensor.

4. The multi-sensored smart cooking apparatus of claim 1 wherein the multi-sensored smart cooking apparatus is configured to turn off, when a sensed temperature of the cooking module is greater than a cooking temperature threshold.

5. The multi-sensored smart cooking apparatus of claim 1 wherein the multi-sensored smart cooking apparatus is configured to turn off, when a sensed weight on the cooking module is less than a weight threshold.

6. The multi-sensored smart cooking apparatus of claim 1 wherein the multi-sensored smart cooking apparatus is configured to turn off, when a sensed water level is less than a water level threshold.

7. The multi-sensored smart cooking apparatus of claim 1 wherein the electronic device includes an application having a payment module for paying for a utility of the multi-sensored smart cooking apparatus.

8. The multi-sensored smart cooking apparatus of claim 1 wherein the electronic device includes an application having a displaying module for displaying a utility consumption of the multi-sensored smart cooking apparatus.

9. The multi-sensored smart cooking apparatus of claim 1 wherein the cooking module is a gas cooking module.

10. The multi-sensored smart cooking apparatus of claim 1 wherein the cooking module is an electric cooking module.

11. A multi-sensored smart stove comprising:
a setting module for setting at least one of a cooking time and a cooking temperature;
a sensing module comprising at least one of a temperature sensor, a weight sensor, and a water level sensor;
a controller coupled to the setting module and the sensing module;
a cooking module coupled to the sensing module and the controller;
an electronic device for remotely controlling the multi-sensored smart stove.

12. The multi-sensored smart stove of claim 11 wherein the electronic device is configured to remotely turn on and off the multi-sensored smart cooking apparatus.

13. The multi-sensored smart stove of claim 11 wherein the electronic device is configured to remotely adjust the cooking temperature of the multi-sensored smart cooking apparatus.

14. The multi-sensored smart stove of claim 11 wherein the multi-sensored smart cooking apparatus is configured to turn off, when a sensed temperature of the cooking module is greater than a cooking temperature threshold.

15. The multi-sensored smart stove of claim 11 wherein the multi-sensored smart cooking apparatus is configured to turn off, when a sensed weight on the cooking module is less than a weight threshold.

16. The multi-sensored smart stove of claim 11 wherein the multi-sensored smart cooking apparatus is configured to turn off, when a sensed water level is less than a water level threshold.

17. The multi-sensored smart stove of claim 11 wherein the electronic device includes an application having a payment module for paying for a utility of the multi-sensored smart cooking apparatus.

18. The multi-sensored smart stove of claim 11 wherein the electronic device includes an application having a displaying module for displaying a utility consumption of the multi-sensored smart cooking apparatus.

19. The multi-sensored smart stove of claim 11 wherein the cooking module is a gas cooking module.

20. The multi-sensored smart stove of claim 11 wherein the cooking module is an electric cooking module.
